(19) United States
(12) Patent Application Publication
(10) Pub. No.: US 2020/0189211 A1
(43) Pub. Date: Jun. 18, 2020

(54) APPARATUS AND METHOD FOR WELDING COMPOSITE THERMOPLASTIC MATERIALS

(71) Applicant: MTI GROUP PTY LTD, Western Australia (AU)

(72) Inventor: Nicholas Bodley, Western Australia (AU)

(21) Appl. No.: 16/303,126

(22) PCT Filed: Nov. 30, 2016
(86) PCT No.: PCT/AU2016/051181

§ 371 Date: Nov. 19, 2018

(30) Foreign Application Priority Data
May 18, 2016 (AU) 2016901857

(51) Int. Cl. B29C 65/00; B29C 65/22; B29C 65/38

(52) U.S. Cl. CPC B29C 66/81831; B31B 70/645; B29C 65/38; B29C 66/3462; B29C 66/3472; B29C 66/712; B29C 66/73116; B29C 66/73921; B29C 66/8324; B29C 66/91421; B29C 66/91445; B29C 65/228; B29C 66/8742; B29C 66/9492; B29C 65/224

(57) ABSTRACT

An apparatus for welding composite thermoplastic materials comprises a welding member configured to receive the composite thermoplastic materials there at; and a controller for controlling a temperature by which composite thermoplastic materials received at the welding member are heated, the controller being configured to provide a plurality of heating cycles during which the composite thermoplastic materials are welded. There is also a method for welding composite thermoplastic materials, the method comprises receiving the composite thermoplastic materials at a welding zone; and applying a plurality of heating cycles to the composite thermoplastic materials at the welding zone.

### FIELD OF THE INVENTION

The present invention relates to an apparatus and method for welding composite thermoplastic materials. In one particular form, the present invention relates to an apparatus and method for sealing plastic tubes woven from strands made from different thermoplastic polymers.

### BACKGROUND

Methods for welding thermoplastic materials are known in the art. Such methods typically involve applying localised heat in order to heat adjacent sheets of thermoplastic materials up to around the melting point of their constituent polymer, whereupon the polymer plasticises and the polymer chains of the adjacent sheets become physically entangled. Upon cooling, the polymer chains remain entangled and a permanent bond is formed between the adjacent sheets.

Such methods are, however, often not effective for welding composite thermoplastic materials (i.e. materials containing two or more discrete polymer portions), and especially so if the melting points of the polymers differ by a significant amount. See for example Table 1, which shows the different melting points of some polymers.

TABLE 1

| | | Specific | Tensile | Yield Strength |
|---|---|---|---|---|
| Materials | Melt Point, ° C. | Gravity | Strength P.S.I | P.S.I |
| Polytetrafluorethelene- | 327 | 2.14-2.20 | 3000-5000 | |
| PTFE | | | | |
| Polyamide-Nylon 6 | 210-220 | 1.12-1.14 | 6000-24000 | 13000 |
| Polyamide-Nylon 66 | 255-265 | 1.13-1.15 | 11000 | 300 |
| Polyester-PET | 220-267 | 1.30-1.38 | 8200-8700 | 8200-8700 |
| Polyethelene | | | | |
| Copolymers - PE | | | | |
| Linear Low & Medium- | 112-124 | 0.918-0.940 | 1900-4000 | 1400-2800 |
| LLDPE | | | | |
| Ethylene Vinyl | 103-110 | 0.922-0.943 | 2200-4000 | 1200-6000 |
| Acetate - EVA | | | | |
| Polyethelene, High | 125-135 | 0.939-0.960 | 2500-6500 | 2800-4800 |
| Density - HDPE | | | | |
| Polypropylene | 150-175 | 0.890-0.905 | 4000-5500 | 3000-4300 |
| Copolymer - PP | | | | |
| Polyurethane | 75-137 | 1.12-1.24 | 4500-9000 | 7800-11000 |
| Vinyl Polymers & | 75-105 | 1.16-1.35 | 1500-3500 | 900-1700 |
| Copolymers - PVC | | | | |

In such cases, heating adjacent composite materials to a temperature sufficient to plasticise the higher melting point polymers in the composite material may burn or otherwise damage the lower melting point polymers in the composite material. Similarly, heating the materials to a temperature at which the lower melting point polymers are plasticised but not damaged might not be sufficient to plasticise the higher melting point polymers, likely resulting in an incomplete or weak weld. Welding of composite thermoplastic materials using such techniques can therefore often result either in damage to the materials, or welds that are incomplete or which have inconsistent properties along the weld. Accordingly, conventional thinking is that it is not possible to weld such materials in an acceptable manner.

It would be advantageous to provide apparatus and methods for welding composite thermoplastic materials, even when the melting points of its constituent polymers differ by a significant amount.

Any references to documents that are made in this specification are not intended to be an admission that the information contained in those documents form part of the common general knowledge known to a person skilled in the field of the invention, unless explicitly stated as such.

### SUMMARY OF THE INVENTION

According to a first aspect, the present invention provides an apparatus for welding composite thermoplastic materials. The apparatus comprises a welding member configured to receive the composite thermoplastic materials and a controller for controlling a temperature by which composite thermoplastic materials received at the welding member are heated. The controller is configured to provide a plurality of heating cycles during which the composite thermoplastic materials are welded.

The invention the subject of the present application came about because of the unexpected discovery that, despite the conventional thinking described above, composite thermoplastic materials can, in fact, be welded, even if the melting points of its constituent polymers differ by a substantial amount, by applying a plurality of heating cycles instead of attempting to form the weld during a single heating cycle. It was also discovered that a plurality of heating cycles is also surprisingly effective for welding thermoplastic materials having variable thicknesses along the length of the weld, with a consistent weld being formable without burning of thinner parts of the material.

As used herein, the term “composite thermoplastic material” is to be understood to mean a thermoplastic material that includes discrete portions of different polymers. The different polymers are not blended in the material and substantially retain their own physical and chemical properties (i.e. a polymer blend is not formed to any significant degree). In some embodiments, the composite thermoplastic materials may comprise woven strands (e.g. threads or filaments) of discrete polymer components, woven into substantially planar sheets, for example. In some embodiments, the composite thermoplastic materials may comprise (or further comprise) an internal and/or external laminate layer (e.g. to improve the durability or waterproofing of the material). Such a laminate layer may, for example, be made from a different polymer than that of those used to form the remainder of the composite thermoplastic material.

In some embodiments, the controller is configured to provide a plurality of heating cycles that each comprise a heating period, during which the composite thermoplastic materials are heated, and a dwell period, during which no heating (or less heating) occurs. The respective durations of each heating and dwell period, as well as the degree of heating in each heating period, can be adapted to suit composite thermoplastic materials.

In some embodiments, the controller is configured to provide a plurality of heating cycles that comprise one or more heating cycles during which the composite thermoplastic materials are heated from a first temperature that is substantially equivalent to a melting point of a first polymer component of the composite thermoplastic materials, to a second temperature that is substantially equivalent to a melting point of a second polymer component of the composite thermoplastic materials. In some embodiments, the first polymer component has the lowest melting point of all polymers in the composite thermoplastic materials. In some embodiments, the second polymer component has the highest melting point of all polymers in the composite thermoplastic materials.

In such embodiments, the composite thermoplastic materials may be heated from the first temperature to the second temperature in a stepwise or pulsed manner, which has been found to even further reduce (or even eliminate) burning of the first polymer component, whilst causing the second polymer component to plasticise in order to reliably form a consistent weld.

In some embodiments, the controller may be configured to rapidly heat the composite thermoplastic materials to the first temperature (e.g. in a first heating cycle). Heating the composite thermoplastic materials to the first temperature relatively quickly would be unlikely to cause any burning of the polymers present in the material but would reduce the overall time required by the welding process.

In some embodiments, the controller may be configured to slowly heat the composite thermoplastic materials from the first temperature to the second temperature over a plurality of heating cycles. As noted above, such slow and pulsed heating may help to facilitate the production of more consistent and reliable welds and without burning occurring.

In some embodiments, the welding member may comprise clamping members, the clamping members being configured to receive and clamp the composite thermoplastic materials therebetween. The clamping members may, for example, be moveable between open and clamping configurations, with the composite thermoplastic materials being positioned to be clamped therebetween.

In some embodiments, one or both of the clamping members may comprise heating elements that are operable by the controller. The heating elements may, for example, be integrally formed with the clamping member, or may be provided as separate components which are brought to bear on the composite thermoplastic materials when the clamping members are clamped together.

In some embodiments, a temperature by which composite thermoplastic materials received at a first portion of the welding member are heated is different to a temperature to which composite thermoplastic materials received at a second portion of the welding member are heated. In this manner, portions of the composite thermoplastic materials can be exposed to different amounts of heat depending, for example, on factors such as a thickness of the materials at that portion or on the types of polymers at that portion. This may help to even further alleviate issues such as burning and incomplete weld formation, as discussed above.

In some embodiments, for example, the first and second portions of the welding member (or clamping member or heating elements) may provide different amounts of heat to respective portions of the received composite thermoplastic materials. The welding member may, for example, comprise heat dissipaters positioned at the first or second portion, which lower the amount of heat applied to the respective portion of the composite thermoplastic materials (e.g. because the materials are thinner at the first portion than at the second portion, or because the discrete polymers received at that portion have a lower melting point than that of the polymers at the second portion).

In an embodiment the apparatus comprises heating bars.

In an embodiment the apparatus comprises rollers on clamping members for vertically spacing the composite thermoplastic materials from the heating bars during drawing of the composite thermoplastic materials through the clamping members so as to prevent rubbing.

In an embodiment the heating bars heat when an electric current is directed through the heating bars. In an embodiment the heating bars are located on the upper and lower clamping members. In an embodiment the heating bars are connected in series.

In an embodiment the apparatus comprises heating bars connected in a configuration such that wiring in the event of a short between the heating bars at least does not result in a short circuit of a power supply.

In an embodiment the heating bars are connected in series by a wire connecting opposite sides.

In an embodiment the apparatus further comprises a housing for holding a dispenser.

According to a second aspect, the present invention provides a method for welding composite thermoplastic materials. The method comprises receiving the composite thermoplastic materials in a welding zone and applying a plurality of heating cycles to the composite thermoplastic materials in the welding zone.

In some embodiments, the plurality of heating cycles may comprise a heating period, during which the composite thermoplastic materials are heated, and a dwell period, during which less heating or no heating occurs.

In some embodiments, the heating cycles may comprise one or more heating cycles during which the composite thermoplastic materials are heated from a first temperature that is substantially equivalent to a melting point of a first polymer component of the composite thermoplastic materials, to a second temperature that is substantially equivalent to a melting point of a second polymer component of the composite thermoplastic materials.

In some embodiments, the composite thermoplastic materials may be rapidly heated to the first temperature. In some embodiments, the composite thermoplastic materials may be slowly heated, over one or more heating cycles, from the first temperature to the second temperature.

In some embodiments, a thinner portion of the composite thermoplastic materials received at the welding zone is heated to a temperature that is lower than a temperature to which a thicker portion of the composite thermoplastic materials received in the welding zone is heated.

In some embodiments, a thinner portion of the composite thermoplastic materials received at the welding zone is heated slower than heating of a thicker portion of the composite thermoplastic materials received in the welding zone.

Specific embodiments of the second aspect of the present invention may be as described herein with respect to embodiments of the first aspect of the present invention.

In this specification the terms “comprising” or “comprises” are used inclusively and not exclusively or exhaustively.

### BRIEF DESCRIPTION OF THE DRAWINGS

In order to provide a better understanding of the present invention embodiments will be described in further detail below with reference to the accompanying drawings, in which:

FIG. 1 is a perspective view of an assembled apparatus for welding a gusseted plastic tube in accordance with an embodiment of the present invention;

FIG. 2 is a perspective view of the apparatus of FIG. 1, having a cover and a readily deployable spool of tubular composite thermoplastic materials;

FIG. 3 shows a spool of gusseted tubular material for use with the apparatus of FIG. 2; and.

FIG. 4 is an exploded view of a portion of an apparatus for welding a gusseted plastic tube in accordance with an embodiment of the present invention.

### DETAILED DESCRIPTION

The present invention provides an apparatus and method for welding composite thermoplastic materials. The apparatus comprises a welding member for receiving the composite thermoplastic materials and a controller for controlling a temperature applied to the composite thermoplastic materials received by the welding member. The controller is configured to provide a plurality of heating cycles during which the composite thermoplastic materials are welded. The method comprises receiving the composite thermoplastic materials at a welding zone and applying a plurality of heating cycles to the composite thermoplastic materials at the welding zone.

Any composite thermoplastic materials having any suitable physical form may be welded in accordance with the present invention.

The thermoplastic materials may be present in the composite thermoplastic materials in any suitable discrete form. In some embodiments, the composite thermoplastic materials may, for example, be discrete polymer layers of a laminate material. In some embodiments, the composite thermoplastic materials may be in the form of strands of discrete polymers which are, for example, woven into substantially planar sheets. For example, as will be discussed in further detail below, tubular sheets having a combination of PP and PE strands in the weave (typically the PP runs in the vertical direction or warp and PE runs in the horizontal direction or weft) have been found to have advantageous properties. In particular, the PP warp offers minimal stretch and excellent abrasion resistance as well as improved environmental factors, whereas the PE weft is present to bind everything together and provides a better hermetic seal, and permits some stretch along the length of the PE weft. As would be appreciated, sheets made from woven materials would be more tear resistant than many other forms of construction.

Such tubes may also have an internal (or external) laminate in order to provide additional advantageous properties (e.g. waterproofing or air resistance). In such cases, a laminate having a similar polymer to that present in the (woven) parent materials might help to improve the weld because the internal lamination is likely to bind better and, during welding, the heat transfer is improved and the heated plastic flows better, binding the parent materials and laminate together with greater mechanical strength. This means that the barrier created by the weld between the outside of the bag and the inside of the bag can be vastly superior to that provided by conventional welding techniques.

Alternatively, the method of the present invention may be useful for welding sheets of two different polymers together, for example, welding a sheet of PE to a sheet of PP.

The composite thermoplastic materials may have any physical form that is suitable for welding. Polymers suitable for welding are typically provided in sheet form because this is easy to weld. In some embodiments, the composite thermoplastic materials may be provided in the form of opposing sides of a flattened tubular member, with the present invention being used to sealingly weld the opposing sides of the tubular member together. Seals produced in this manner have been found to be more complete and structurally sound than can be formed by using prior welding methods.

The composite thermoplastic materials may have a variable thickness across the portion to be welded, as may be the case, for example, where a fold in the material is intended to be incorporated into the weld. Incorporating such a fold into the weld may result in the resultant welded material having a particular configuration, which may be advantageous for some applications. Such a fold may also be useful for the reasons discussed below in the context of the gusseted liner.

The apparatus of the present invention has a welding member for receiving the composite thermoplastic materials and subsequently welding them. The welding member may have any form, provided that it is capable of welding the composite thermoplastic materials in the manner described herein.

As pressure is typically required in order to effectively weld plastic materials, the welding member may have clamping members that are configured to receive and clamp the composite thermoplastic materials therebetween. Such clamping members may be moved between an open configuration, where the composite thermoplastic materials may be positioned between the members in an appropriate place, and a clamping configuration, where composite thermoplastic materials are securely clamped therebetween. The clamping members should be capable of providing a clamping force appropriate for the given welding application.

One or both of the clamping members may also have heating elements that are operable by the controller in order to heat up the clamped composite thermoplastic materials. The heating element(s) may either be integrally provided with the clamping members, or provided separately but operatively associated with the clamping members so that the heat produced by the heating element(s) is applied to the clamped material. The heating elements may be formed into a bar of any suitable heat-generating material, such as, for example, a Nichrome heating element. Typically, the amount of electrical current caused to pass through the heating element(s) is used to control the temperature by which the heating element increases (or decreases) and hence the temperature of the composite thermoplastic materials at the weld zone.

One or both of the clamping members may also include other components, such as non-stick materials (e.g. polytetrafluoroethylene, which is sold under the brand Teflon™) for substantially preventing the composite thermoplastic materials from becoming stuck to the clamping members.

The controller is for controlling a temperature applied to the composite thermoplastic materials received by the welding member. The controller is configured to provide a plurality of heating cycles, during which the composite thermoplastic materials are welded.

Any suitable controller may be used to heat the composite thermoplastic materials in the welding member. As noted above, the controller is typically configured to control an amount of current flowing and duration of the current flow through a heating element on or in the welding member, with the amount of electrical current caused controlling the temperature of the heating element and hence the temperature of the composite thermoplastic materials at the weld zone. Suitably programmed Programmable Logic Controllers (PLCs) may, for example, be used for this purpose. Other suitable electronic circuits or computing devices may also be used as the controller.

The controller may, in some embodiments, be programmed to provide different heating cycles for use with different composite thermoplastic materials. In its simplest form, however, the controller may be configured to provide the same plurality of heating cycles (i.e. which are suitable for welding specific composite thermoplastic materials).

The controller may, for example, be configured to provide a plurality of heating cycles including a heating period, during which the composite thermoplastic materials are heated, and a dwell period, during which no heating (or less heating) occurs. In some embodiments, the controller (or another component of the apparatus) may be capable of cooling the composite thermoplastic materials for a period of time. Such a pulsed heating program has been found to be especially effective for welding composite thermoplastic materials, even when the constituent polymers have significantly different melting points, or when the thickness of the composite thermoplastic materials vary across the weld.

The composite thermoplastic materials may be heated in a manner that results in a reliable weld being formed and in the light of the present disclosure, a person skilled in the art will be readily able to formulate a heating cycle applicable to given composite thermoplastic materials for welding and the physical form in which they are provided (e.g. gusseted, etc.).

The controller may, for example, be configured to provide a plurality of heating cycles that comprise one or more heating cycles during which the composite thermoplastic materials are heated from a first temperature that is substantially equivalent to a melting point of a first polymer component of the composite thermoplastic materials, to a second temperature that is substantially equivalent to a melting point of a second polymer component of the composite thermoplastic materials. In this manner, a gradual, pulsed heating program is applied to the material which has been found to significantly reduce burning of the first polymer component.

Typically, the first polymer component referred to above is the polymer having the lowest melting point of all of the polymers in the composite thermoplastic materials. Similarly, typically, the second polymer component is the polymer having the highest melting point of all polymers in the composite thermoplastic materials.

The controller may, for example, be configured to rapidly heat the composite thermoplastic materials to the first temperature. For example the controller may build up the temperature in 100 ms pulses. Temperature is a function of time, current and resistance of the element. Current is constant as it is set through a voltage regulator. Resistance is constant. By changing time the temperature can be controlled. Burning of any component in the composite thermoplastic materials would be unlikely to occur under this temperature, and rapidly heating the material up to this temperature would help to reduce the overall time taken to produce the weld. Indeed, the controller may be configured to rapidly heat the composite thermoplastic materials to the first temperature in a first heating cycle, for example.

Following an initial rapid heating cycle, the controller may be configured to slowly heat the composite thermoplastic materials from the first temperature to the second temperature over a plurality of heating cycles in order to strengthen the weld formed whilst reducing the likelihood of any burning occurring.

A PLC program may, for example, run the heat cycle using the following logic:
a) Cover of welder is closed and interlock safety switch is engaged and locked, thus beginning the weld cycle
b) Heat time of 0.1-4 sec (variable in program) according to the type of plastics being welded. This may be at for example a temperature in the range of 75 to 250° C.
c) Dwell time of 0.1-4 sec (variable in program)
d) Heat time of 0.1-4 sec (variable in program)
e) Dwell time of 0.1-4 sec (variable in program)
f) Heat time of 0.1-4 sec (variable in program)
g) Dwell time of 0.1-4 sec (variable in program)
h) Heat time of 0.1-4 sec (variable in program)
i) Dwell time of 0.1-4 sec (variable in program)
j) Can add or remove Heat and dwell cycles as required
k) Cooling time of 2-30 sec (variable in program)
l) An indicator for indicating that the welding has been completed.

As noted above, in some embodiments, a thickness of the composite thermoplastic materials across the weld zone may vary (e.g. when the weld incorporates one or more folds of the material, as is the case for the gusseted liner described below). In such embodiments, it may be advantageous if the temperature by which composite thermoplastic materials received at a first portion of the welding member are heated is different to the temperature by which composite thermoplastic materials received at a second portion of the welding member are heated. For example, it may be advantageous if a thinner portion of the composite thermoplastic materials was heated to a lower temperature and or slower than that of a thicker portion of the materials. Whilst the higher temperature may be required to weld the thicker portion, heating the thinner portion in this manner may help to reduce the risk of burning occurring at this portion.

Any method by which such variable heating can be applied may be used in the present invention. In some embodiments, for example, the first and second portions of the welding member may provide different amounts of heat to respective portions of the composite thermoplastic materials received thereat. For example, the welding member may include one or more heat dissipaters positioned at the first or second portion, whereby the heat dissipaters lower the amount of heat applied to the respective portion of the composite thermoplastic materials. Alternatively, multiple heating elements may be provided to apply controlled amounts of heat.

The apparatus of the present invention may include additional features to further improve its performance. In some embodiments, for example, the apparatus may have a dispenser for holding and dispensing the composite thermoplastic materials for welding. Such a dispenser may, when the material is in sheet form, include a spool operatively coupled to and in alignment with the welding member.

The apparatus may also include safety features such as electrical cut outs and heat shields to prevent a person accidentally touching a hot surface.

In an embodiment the apparatus further comprises a housing for holding a dispenser.

The apparatus may be run using mains power or using 12 or 24V DC power sources, for example, when the apparatus is to be used in the field.

A specific embodiment of the present invention will be described below in the context of the composite thermoplastic materials for welding being opposing sides of a gusseted tube for lining a blast hole at a site where blasting is to take place (e.g. in a mine or during a road construction, for example). It is to be appreciated, however, that this detailed description is simply for illustrative purposes, and that the present invention has much broader applicability than just this application.

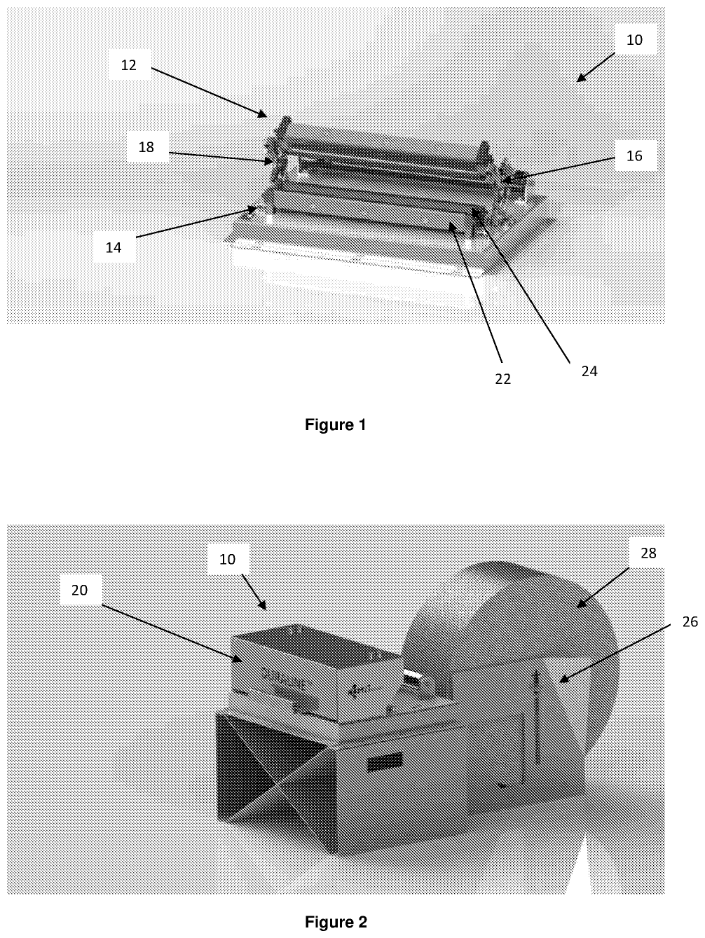

Referring now to FIG. 1, an apparatus for welding a gusseted plastic tube is shown in the form of welder 10. Welder 10 has an upper clamping member 12 and a lower clamping member 14, which are clampable together because the members 12, 14 are affixed between the arms of toggle clamps 16 and 18. Clamping of the upper 12 and lower 14 clamping members is achieved through the lever action of toggle clamps 16 and 18, which are capable of 340 kg holding capacity. Although not shown in FIG. 1, toggle clamps 16 and 18 can be built into the lid 20 (see FIG. 2), such that the simple operation of opening and closing the lid 20 causes the upper 12 and lower 14 clamping members to move between open and clamping positions (compare FIGS. 1 and 2).

Each of upper clamping member 12 and a lower clamping member 14 have two independent sealing jaws 22, 22 and 24, 24 (only numbered on the lower clamping member 14 for clarity) respectively. Jaws 22 and 22 align with and abut each other when in the clamped position (not shown). The jaws are configured to ensure even and localised heat concentration. The jaws are sized according to the material ie 300 mm Jaw for 240 mm material—this means that there are no hot spots as the material absorbs most of the heat. If the bar is much longer than the material, the heat cannot be effectively dissipated and there may be hot spots. Similarly, Jaws 22 and 22 align with and abut each other when in the clamped position (not shown). Jaws 22, 22 and 24, 24 are on different electrical circuits to each other so that when one jaw set (e.g. jaws 22, 22) requires maintenance (e.g. replacement of its element or its Teflon coating, as discussed below), a toggle switch will allow operators to switch to the other jaw set (e.g. 24, 24) without disrupting operations whilst maintenance is conducted.

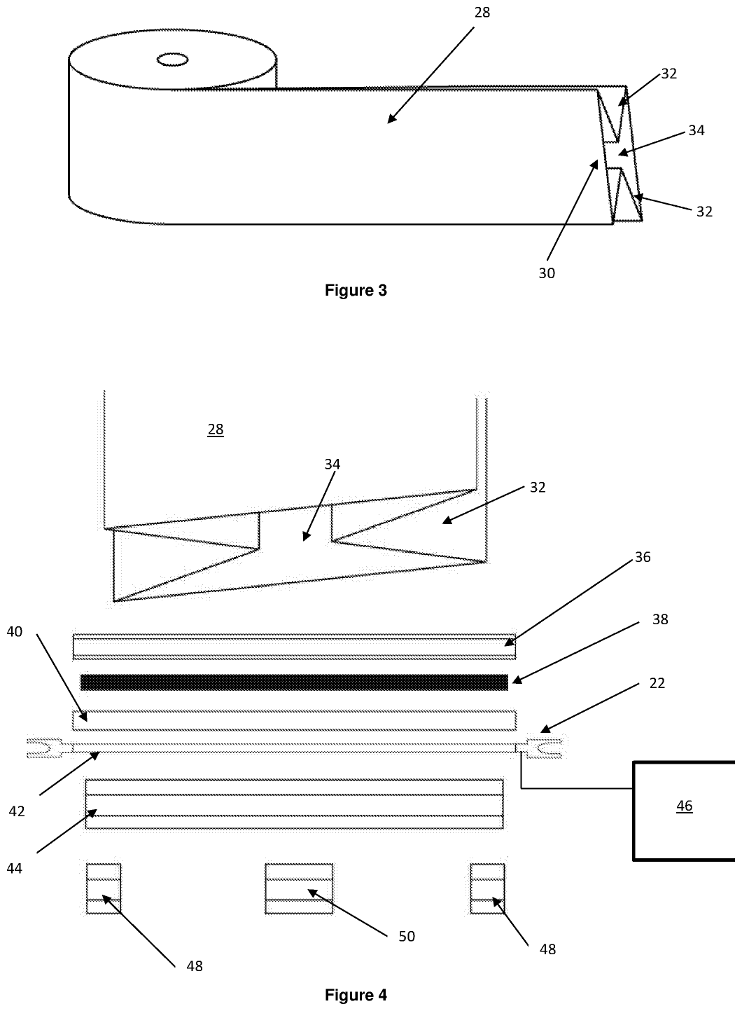

Referring now to FIG. 2, the welder 10 is shown having a lid 20 and a dispenser 26, which contains a roll of gusseted tube 28 (see also FIG. 3). The dispenser 26 can freely rotate in order for the gusseted tube 28 to be readily dispensed when pulled. The dispenser 26 is positioned on the welder 10 such that the dispensed portion of the gusseted tube 28 can be fed through the upper 12 and lower 14 clamping members (and hence welded, as described below). The dispenser 26 enables bulk tube dispensing and roll on loading in order to reduce manual handling.

Although not shown, lid 20 includes an interlock safety switch, which is activated in order to ensure that the lid 20 cannot be opened during the welding cycle (as discussed below), as well as an indicator light to show when the lid is locked and/or when the welding cycle is in progress. The welder 10 may also include a buzzer (not shown) to indicate, for example, when a welding cycle has been completed. Advantageously, locking the lid 20 to the body of the welder 10 can also help to avoid vibration damage to the lid (especially its alignment) whilst the welder is transported over rough terrain.

The roll of gusseted tube 28 is shown more clearly in FIG. 3 and includes an open end 30 having two gusseted edge portions 32, 32 and a central portion 34. Advantageously, the large gussets 32, 32 can almost halve the effective lay-flat width of the tube 28, which can make installation far easier and quicker. As an example; a hole with a diameter of 270 mm has a circumference of 850 mm. The lay-flat width of the material required to adequately line this diameter hole would be 420-440 mm (850 mm/2). This means that the lay-flat width 440 mm is greater than the diameter 270 mm. However, twisting of such a tube can often occur during installation, and the relatively large surface area on the liner can, in some cases, stick to the blast hole walls. It has been found, however, that applying a 100 mm gusset on both sides reduces the packaged width of the material from 440 mm to 240 mm. This equates to a packaged width which is less than the diameter of the hole, which has been found to significantly improve the application in terms of speed and ease of installation and almost eliminating liner twisting and sticking in the blast hole.

Although not shown in detail in the Figures, the gusseted liner 28 has the structure discussed above, namely a woven exterior with a PP warp and a PE weft, as well as a thin interior layer of Ethylene Vinyl Acetate (EVA) and PE to improve the liner's water resistance.

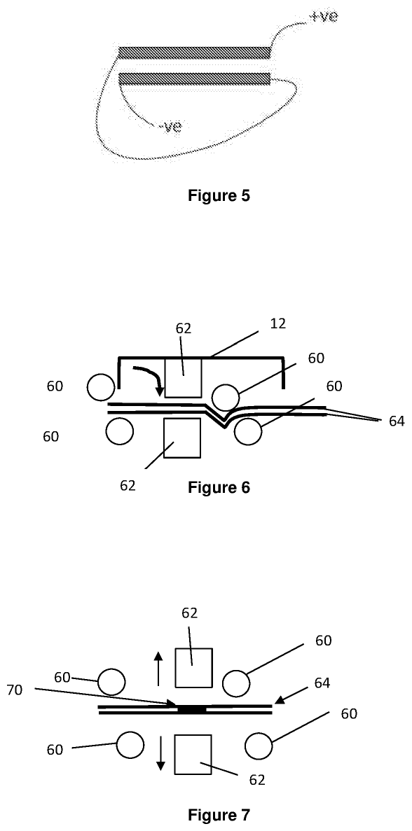

The sealing jaws 22, 22 and 24, 24 will now be described with reference to FIG. 4, which shows an exploded view of jaw 22 (for example). Jaw 22 includes a cover member in the form of an aluminium jaw 36, which is a good conductor of heat and against which the gusseted liner 28 will be clamped for welding. Jaw 22 also includes a silicon backing pad 38 which allows the heating element to form better over folds as the clamping force is better distributed. Without the pad 38 the high points would receive most of the clamping force and the seal here would be too thin. Jaw 22 also includes a Teflon backing tape 40 which covers the backing pad. This can extend the service life and allows the element to expand and contract during heating, and substantially prevents sticking of the element 42 to the backing pad 38. Jaw 22 also includes a Nichrome heating element 42, which is operable to heat the gusseted liner 28 when clamped between the jaws 22, 22. The heating element 42 is located between zone tape cover strip 44 and the Teflon backing tape 40, which acts as a release surface. Heat is only generated by heating element 42 when current flows which, as will be described in further detail below, is controlled by a controller 46. Zone tape 48 and 50 retard heat transfer in these zones due to reduced material thickness. This reduces hot spots. Both jaws are set up identically, and include the redundant pair 24.

The heating bars heat when an electric current is directed through the heating bars. It is preferable they be connected in series so as to reduce the current drawn from the power supply. The heating bars may be located on the upper and lower clamping members and may be connected in a configuration such that wiring in the event of a short between the heating bars at least does not result in a short circuit of the power supply. The wiring can be so that there is wire connecting opposite sides of the heating bars as shown in FIG. 5. The heating bars are part of heating element 42 The wire connecting from the top heating bar to the opposite side of the bottom heating bar, as shown in the embodiment of FIG. 5, ensures that if a short circuit occurs, a small amount of current will still flow. If the heating bars are connected so that the top heating bar end is connected to the same location at the end of the bottom heating bar, a maximum current will occur in the event that the bars touch and create a short circuit. This is not desirable, as the bars will then be touching and receiving a maximum amount of current flow and thereby shorting the power supply. The configuration of FIG. 5 solves this problem by reducing the amount of current flow when the heating bars are touching, so as to prevent a short circuit of the power supply from occurring.

FIG. 6 illustrates the clamping members which include rollers 60 that create a vertical space between the composite thermoplastic material 64 and the heating bars 62 when the composite thermoplastic material 64 is drawn through the clamping members so as to prevent rubbing through of the composite thermoplastic material 64, as shown in FIG. 6. The heating bars after heating are then separated as shown in FIG. 7, and the rollers 60 are moved apart at the same time, with a seal 70 in the composite thermoplastic material 64 where the heating has occurred.

When the liner 28 is placed between the upper 12 and lower 14 clamping members of the welder 10, they are held in place by the pressure exerted by the members (in particular, jaws 22, 22 and 24, 24). An electric current heats the heating element 42 for a specified time to create the required temperature and plasticise the discrete polymer components of the gusseted liner 28. The clamping members 12, 14 then hold the gusseted liner 28 in place for a period of time after the heat is stopped, which allows the opposite sides of the gusseted liner 28 to fuse together (i.e. become welded).

The jaw 22 also includes edge gusset cover strips 48, 48 and central gusset cover strips 50.

Controller 46 controls the temperature of the heating element 42 (by controlling the amount of electrical current flowing therethrough) and hence controls the temperature applied to the gusseted liner 28 along the length of element 42. The controller 46 is programmable to provide a plurality of heating cycles, over the duration of which the composite polymer groups present in the opposing sides of the gusseted liner 28 plasticise and become welded together, thereby creating a substantially watertight seal across the gusseted liner 28. The controller 46 (and indeed, other parts of the welder 10) can be run from mains power or, more likely, a 12 or 24V supply (e.g. when in a portable form and mounted on mobile equipment).

In the embodiment described, the plurality of heating cycles proceed in the following order: The principle behind the pulsing is that the heat transfer to the material is quick and by pulsing, the chance of burning is reduced, but pulsing also reduces the heat put into the jaws. If the jaws heat up, the welding may be inconsistent.
Once the cover of welder 10 is closed and the interlock safety switch is engaged and locked, the weld cycle can begin:
Heat time of 0.1-4 sec (variable in program)
Dwell time of 0.1-2 sec (variable in program)
Heat time of 0.1-4 sec (variable in program)
Dwell time of 0.1-2 sec (variable in program)
Heat time of 0.1-4 sec (variable in program)
Dwell time of 0.1-2 sec (variable in program)
Heat time of 0.1-4 sec (variable in program)
Dwell time of 0.1-2 sec (variable in program)
Cooling time of 1-30 sec (variable in program)
The light indicator and/or buzzer will indicate when the weld cycle has completed, after which time the operator can push a button to release the lid and interlock safety switch and open up the clamping members 12, 14.

This pulse welding program avoids excessive heat generation whilst, as noted above, the jaws 22, 22 (or 24, 24) ensures even and localised heat concentration. It has been found that having a similar polymer group present in the parent material (weave) means that the internal lamination binds better and during welding the heat transfer is improved and the heated plastic flows better, binding the parent and laminate together with greater mechanical strength. This means that the barrier created by the weld between the outside of the liner and the inside of the liner is vastly superior.

As will be appreciated, welder 10 is constructed in a manner that makes it suitable for use in the field, for example on the back of an explosives vehicle. Weather resistance, durability and a minimum number of parts are all desirable features. The sheet metal components of the welder 10 may, for example, be manufactured from 3 mm thick SS316 sheet metal. As noted above, the lid 20 is fitted with an interlock safety limit switch, which will lock the lid 20 before being able to initiate the welding cycle and typically includes an emergency stop to kill the electrical circuit in the event of an emergency. The welder 10 has low maintenance requirements and built in redundancy due to the two pairs of independent sealing jaws (i.e. 22, 22 and 24, 24).

Specific embodiments of the apparatus and method for welding composite thermoplastic materials of the present invention may have one or more of the following advantages:
reliable welds can be formed in composite thermoplastic materials without burning of one or more of its polymer components occurring;
the apparatus can be provided in portable form for use in the field;
plastic liners having optimal strength and loading properties can be used with wet blast holes.
Liners can be fabricated to a length according to the hole they are intended to be used in.

It will be appreciated by those skilled in the art that variations and modifications to the embodiments of the invention described herein will be apparent without departing from the spirit and scope thereof. The variations and modifications as would be apparent to persons skilled in the art are deemed to fall within the broad scope and ambit of the invention as herein set forth.

1. An apparatus for welding composite thermoplastic materials, the apparatus comprising:
a welding member configured to receive the composite thermoplastic materials there at; and
a controller for controlling a temperature by which composite thermoplastic materials received at the welding member are heated, the controller being configured to provide a plurality of heating cycles during which the composite thermoplastic materials are welded.

2. An apparatus for welding composite thermoplastic materials according to claim 1, wherein the controller is configured to provide a plurality of heating cycles that each comprise a heating period, during which the composite thermoplastic materials are heated, and a dwell period, during which no heating (or less heating) occurs.

3. An apparatus for welding composite thermoplastic materials according to claim 1, wherein the respective durations of each heating and dwell period, as well as the degree of heating in each heating period, can be adapted to suit composite thermoplastic materials.

4. An apparatus for welding composite thermoplastic materials according to claim 1, wherein the controller is configured to provide a plurality of heating cycles that comprise one or more heating cycles during which the composite thermoplastic materials are heated from a first temperature that is substantially equivalent to a melting point of a first polymer component of the composite thermoplastic materials, to a second temperature that is substantially equivalent to a melting point of a second polymer component of the composite thermoplastic materials.

5. An apparatus for welding composite thermoplastic materials according to claim 4, wherein the first polymer component has the lowest melting point of all polymers in the composite thermoplastic materials.

6. An apparatus for welding composite thermoplastic materials according to claim 5, wherein the second polymer component has the highest melting point of all polymers in the composite thermoplastic materials.

7. An apparatus for welding composite thermoplastic materials according to claim 4, wherein the composite thermoplastic materials is heated from the first temperature to the second temperature in a stepwise or pulsed manner.

8. An apparatus for welding composite thermoplastic materials according to claim 4, wherein the controller is configured to rapidly heat the composite thermoplastic materials to the first temperature.

9. An apparatus for welding composite thermoplastic materials according to claim 4, wherein the controller is configured to slowly heat the composite thermoplastic materials from the first temperature to the second temperature over a plurality of heating cycles.

10. An apparatus for welding composite thermoplastic materials according to claim 1, wherein the welding member comprises clamping members, the clamping members being configured to receive and clamp the composite thermoplastic materials there between.

11. An apparatus for welding composite thermoplastic materials according to claim 10, wherein the heating elements are integrally formed with the clamping members.

12. An apparatus for welding composite thermoplastic materials according to claim 1, wherein a temperature by which composite thermoplastic materials received at a first portion of the welding member are heated is different to a temperature to which composite thermoplastic materials received at a second portion of the welding member are heated.

13. An apparatus for welding composite thermoplastic materials according to claim 12, wherein the first and second portions of the welding member provide different amounts of heat to respective portions of the received composite thermoplastic materials.

14. An apparatus for welding composite thermoplastic materials according to claim 13, wherein the welding member comprises heat dissipaters positioned at the first or second portion, which lower the amount of heat applied to the respective portion of the composite thermoplastic materials.

15. An apparatus for welding composite thermoplastic materials according to claim 1, wherein the apparatus comprises heating bars, wherein welding occurs by heating one of the bars above the composite thermoplastic and another of the bars is below the composite thermoplastic, and the bars are heated according to the same heating cycles.

16. An apparatus for welding composite thermoplastic materials according to claim 15, wherein the apparatus comprises rollers on clamping members for vertically spacing the composite thermoplastic materials from the heating bars during drawing of the composite thermoplastic materials through the clamping members so as to prevent rubbing.

17. An apparatus for welding composite thermoplastic materials according to claim 15, wherein the heating bars heat when an electric current is directed through the heating bars.

18. An apparatus for welding composite thermoplastic materials according to claim 15, wherein the heating bars are located on the upper and lower clamping members.

19. An apparatus for welding composite thermoplastic materials according to claim 15, wherein the heating bars are connected in series.

20. An apparatus for welding composite thermoplastic materials according to claim 15, wherein the apparatus comprises heating bars connected in a configuration such that wiring in the event of a short between the heating bars at least does not result in a short circuit of a power supply.

21. An apparatus for welding composite thermoplastic materials according to claim 15, wherein the heating bars are connected by a wire connecting opposite sides.

22. An apparatus for welding composite thermoplastic materials according to claim 1, wherein the apparatus further comprises a housing for holding a dispenser of the thermoplastic materials.

23. A method for welding composite thermoplastic materials, the method comprising:
receiving the composite thermoplastic materials at a welding zone; and
applying a plurality of heating cycles to the composite thermoplastic materials at the welding zone.

24. A method for welding composite thermoplastic materials according to claim 23, wherein the plurality of heating cycles comprises a heating period, during which the composite thermoplastic materials are heated, and a dwell period, during which less heating or no heating occurs.

25. A method for welding composite thermoplastic materials according to claim 23, wherein the heating cycles comprise one or more heating cycles during which the composite thermoplastic materials are heated from a first temperature that is substantially equivalent to a melting point of a first polymer component of the composite thermoplastic materials, to a second temperature that is substantially equivalent to a melting point of a second polymer component of the composite thermoplastic materials.

26. A method for welding composite thermoplastic materials according to claim 25, wherein the composite thermoplastic materials are rapidly heated to the first temperature.

27. A method for welding composite thermoplastic materials according to claim 26, wherein the composite thermoplastic materials are slowly heated, over one or more heating cycles, from the first temperature to the second temperature.

28. A method for welding composite thermoplastic materials according to claim 23, wherein a thinner portion of the composite thermoplastic materials received at the welding zone is heated to a temperature that is lower than a temperature to which a thicker portion of the composite thermoplastic materials received in the welding zone is heated.

29. A method for welding composite thermoplastic materials according to claim 28, wherein a thinner portion of the composite thermoplastic materials received at the welding zone is heated slower than heating of a thicker portion of the composite thermoplastic materials received in the welding zone.
